(19) United States
(12) Patent Application Publication
(10) Pub. No.: US 2021/0184627 A1
(43) Pub. Date: Jun. 17, 2021

(54) HYBRID PHOTOVOLTAIC AND THERMAL SOLAR CONCENTRATOR

(71) Applicant: Marjan NENOV, Skopje (MK)

(72) Inventor: Marjan NENOV, Skopje (MK)

(21) Appl. No.: 17/269,420

(22) PCT Filed: Mar. 19, 2019
(86) PCT No.: PCT/MK2019/000001

§ 371 Date: Feb. 18, 2021

(30) Foreign Application Priority Data
Jul. 2, 2018 (MX) MK/P/2018/513

(51) Int. Cl. H02S 40/44; H02S 40/22; A01G 9/24; H02S 40/42

(52) U.S. Cl. CPC H02S 40/44; H02S 40/425; A01G 9/243; H02S 40/22

(57) ABSTRACT

The sunlight is collected by a light concentrating tube or a light concentrating funnel, after which light transporting multi wire cable or light transporting full cable tied in bundles of light transporting cables bring in the Sun rays through the tubular opening in the electrical module of the dark chamber between the photovoltaic panels for the production of electrical energy, through which heat energy is released through the tubular openings and built-in fans it is transported into the heating module of the dark chamber and the cooling module of the dark chamber, The modules are interconnected with tubular openings for transportation of the heated air, hot air inlet tubular opening and hot air outlet tubular opening coordinated through the inverter and the voltage control units interconnected with electrical cables. Concentrators of light through the light concentrating tube and the light concentrating funnel, through light transporting multi wire cable and light transporting full cable, as a separate technical solution can directly transport Sun rays into heating body-jar placed in soil in greenhouse.

### TECHNOLOGY FIELD

Energy Combined Sun Central belongs to an area of devices for the production of electrical and thermal energy as well as cooling of air and liquid, according to the international classification MKP the invention is classified and marked with. . . .

### THE STATE OF THE TECHNOLOGY

In the field of energy devices, we are familiar with devices for converting solar into electrical energy—photovoltaic, which are stored in batteries—accumulators, and we are also familiar with devices that use solar energy for production of heat energy.

### TECHNICAL SOLUTION

The technical solution offered by this invention consists of the fact that sunlight through specially designed concentrators of light energy, through light transporting cables, transmits light into a dark chamber where the photovoltaic panels are illuminated, which produces electrical energy that is stored in batteries for immediate and delayed use in the process of production of electrical energy in the dark chambers, the heat that is released is transported in the upgraded modules for heating and cooling.

### PROFILE DESCRIPTION

The light concentrators through the light concentrating tube and the light concentrating funnel as separate technical solutions, concentrate light and through light transporting cables, transport it into the dark chamber, which consists of an outer metal construction insulated with sandwich insulation where In the central interior with metal elements-separators is placed an Internal metal construction where photovoltaic panels are placed on all six sides, facing the photovoltaic cells towards the inside of the construction. Light transporting cables with insulation form light transporting cable bundles that penetrate through at least one outlet of the outer construction, pass through the inter space between the outer and inner constructions in the photovoltaic panels openings, execute photovoltaic lighting, which produces electrical energy directed towards the inverter which is connected to electrical energy storage batteries and a voltage controller connected to thermostats and fans that transport the heated air to upgraded modules for heating and cooling. The invention also includes the use of a light concentrating tube and a light concentrating funnel with cables for transmission of solar energy in greenhouses, where it is used for lighting but also for the accumulation of heat in heat absorbers embedded in the soil for heating.

The invention is described in detail on the example of the performance shown on the drawings on which:

FIG. 1—Light concentrating tube

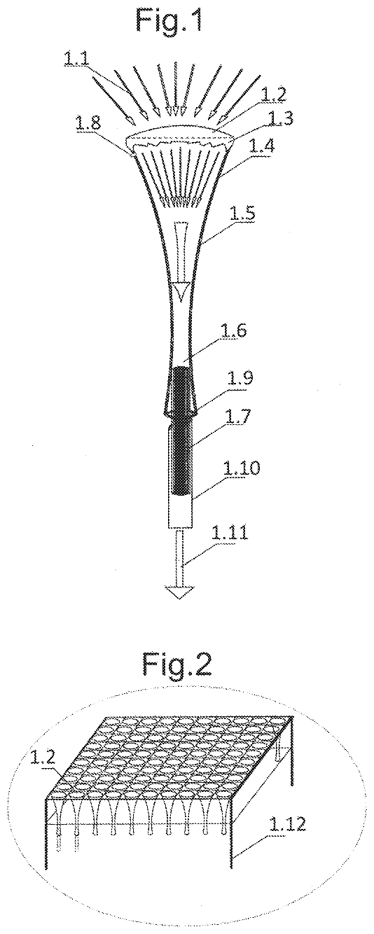

FIG. 2—Lattice carrier for light concentrating tube

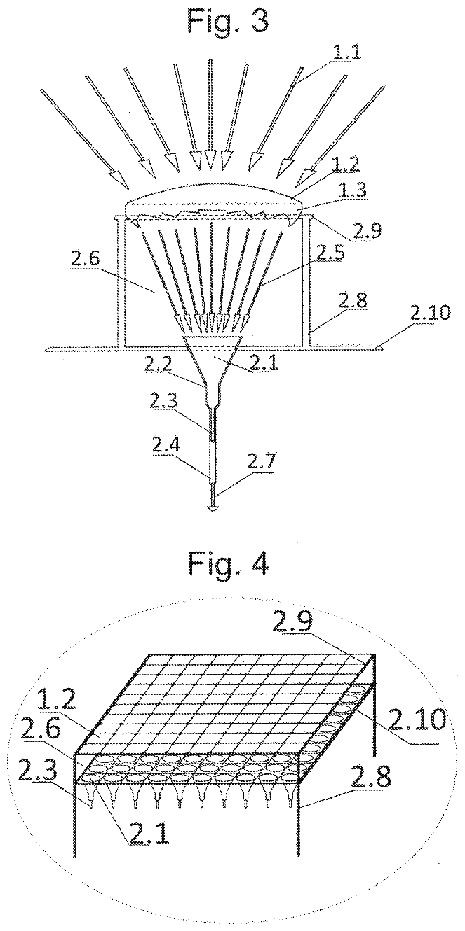

FIG. 3—Light concentrating funnel

FIG. 4—Grid mount

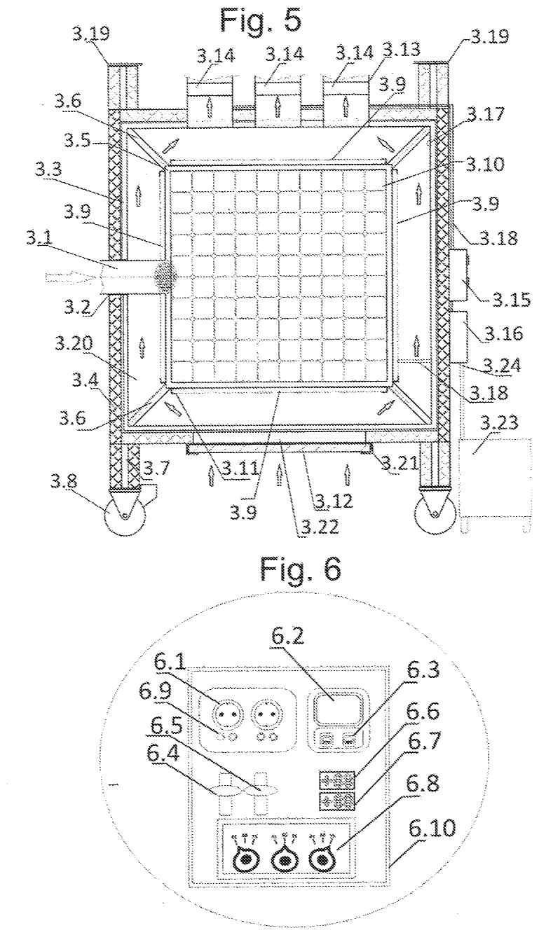

FIG. 5—Electrical module of the dark chamber cross section

FIG. 6—Voltage control unit

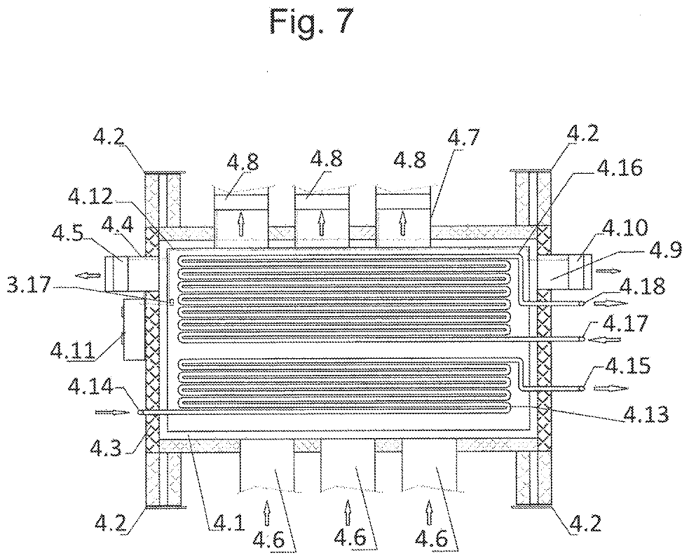

FIG. 7—Dark chamber heating module cross section

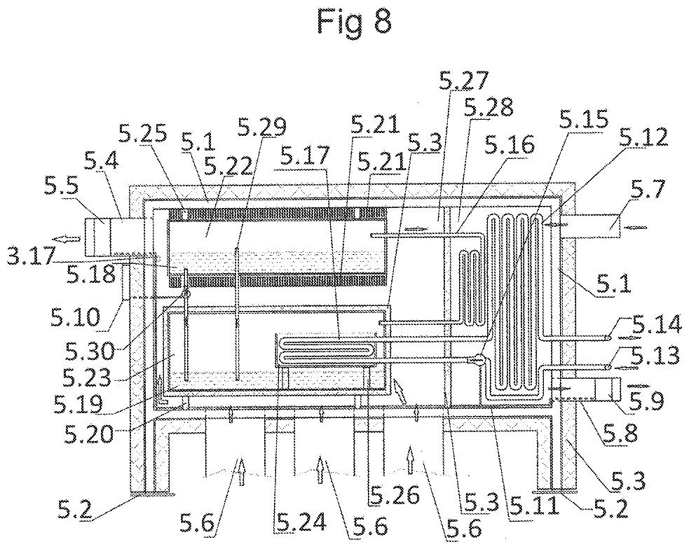

FIG. 8—Dark chamber cooling module cross section

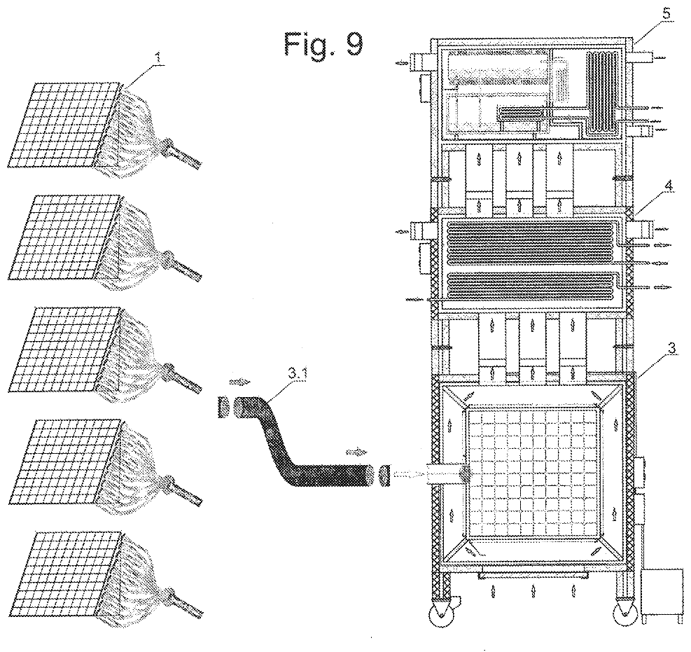

FIG. 9—ECo Sun Central complete display schematic view

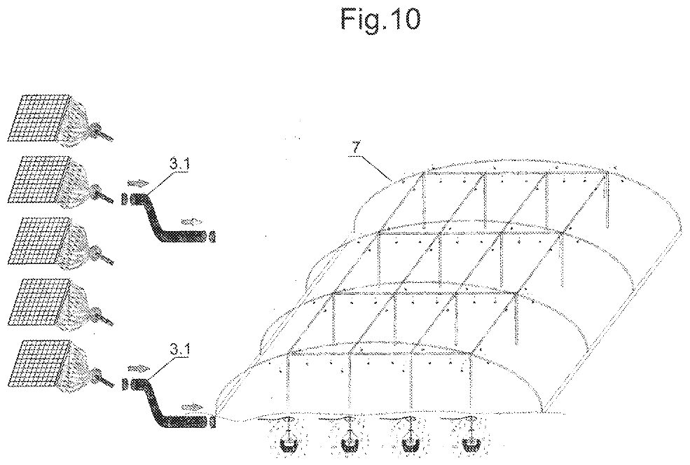

FIG. 10—Solar thermal greenhouse schematic view

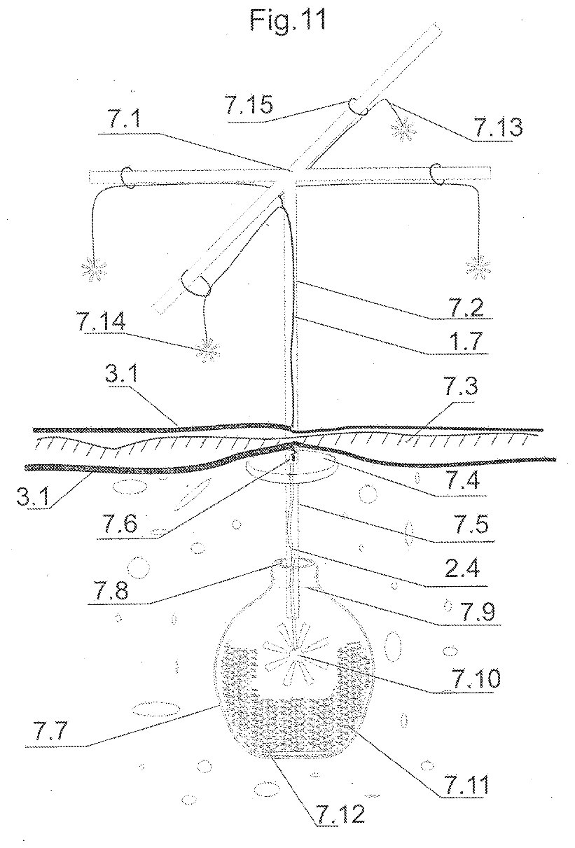

FIG. 11—Part of the construction of the green house with heating body-jar and heat absorbers

### LEGEND

The tags from the Energy Combined Solar Center

1. Light concentrating tube (1), (FIG. 1)

1.1. Sun rays

1.2. Convex lens

1.3. Fresnel lens

1.4. Body of a concentrating tube

1.5. Mirror coating

1.6. introducer for a light transporting cable

1.7. Light transporting multi wire cable

1.8. Vacuum pin

1.9. Silicone seal

1.10. Insulation

1.11. Transported concentrated light

2. Lattice carrier for light concentrating tube (FIG. 2)

1.2 Convex lens

1.12. Lattice carrier for light concentrating tube

3. Light concentrating funnel (2), (FIG. 3)

1.1. Sun rays

1.2. Convex lens

1.3. Fresnel lens

2.1. Light funnel (with fiber extension 2.3.)

2.2. Mirror coating

2.3 Fiber extension (soldered to light transporting full cable)

2.4. Light transporting full cable

2.5. Focused light rays

2.6. Air distance

2.7. Transported concentrated light

2.8. Grid mount

2.9. Upper grid

2.10. Lower grid

4. Grid mount (FIG. 4)

1.2. Convex lens

2.1. Light funnel (with fiber extension 2.3.)

2.3. Fiber extension (soldered to light transporting full cable)

2.6. Air distance

2.8. Grid mount

2.9. Upper grid

2.10. Lower grid

5. Electrical module of the dark chamber (3), (FIG. 5)

3.1. Bundles of light transporting cables

3.2. Tubular opening

3.3. Outer metal construction

3.4. Sandwich insulation

3.5. inner metal construction

3.6. Metal joint elements

3.7. Metal legs

3.8. Wheels

3.9. Photovoltaic panels

3.10. Photovoltaic cells

3.11. Holders

3.12. Air filter

3.13. Tubular openings

3.14. Built-in fans

3.15. Voltage control unit

3.16. Inverter

3.17. Thermal probes

3.18. Electrical cable

3.19. Carriers with coupling elements

3.20. Air space

3.21. Air filter holder

3.22. Air inlet opening

3.23 Batteries

3.24. Electrical cable for batteries

6. Voltage control unit (FIG. 6)

6.1. Voltage Input/Output

6.2. Control SMART tile

6.3. Control network Input/Output

6.4. Fuse

6.5. Switch

6.6. Outlet temperature indicator

6.7. inlet temperature indicator

6.8. Thermostats for fans

6.9. DC power Input/Output

6.10. Front of the housing

7. Dark chamber heating module (4), (FIG. 7)

4.1. Metal construction

4.2. Carriers with coupling elements

4.3. Sandwich insulation

4.4. Outlet for discharging excess hot air

4.5. Fan

4.6. Hot air inlet tubular openings

4.7. Hot air outlet tubular openings

4.8. Fans for outlet of hot air

4.9. Opening for air heating

4.10. Fan for air heating

4.11. Voltage control unit

4.12. Electrical cables

4.13. Pipe for sanitary water

4.14. Inlet opening for sanitary water

4.15. Outlet opening for sanitary water

4.16. Spiral pipe for heating

4.17. inlet opening of spiral pipe for heating

4.18. Outlet opening of spiral pipe for heating

8. Dark chamber cooling module (5), (FIG. 8)

5.1. Metal construction

5.2. Carriers with coupling elements

5.3. Sandwich insulation

5.4. Pipe for outlet of excess air

5.5. Fans for outlet of hot air

5.6. Hot air inlet tubular openings

5.7. Tubular opening for entry of outside air

5.8. Pipe for air-cooling

5.9. Fan for air-cooling

5.10. Voltage control unit

5.11. Electrical cable

5.12. Cooling pipe

5.13. Inlet of the cooling pipe

5.14. Outlet of the cooling pipe

5.15. Pump

5.16. Condenser

5.17. Evaporator

5.18. Saturated solution

5.19. Diluted solution

5.20. Holder of dosed container with diluted solution

5.21. Heat absorbers

5.22. Closed container with saturated solution

5.23. Closed container with diluted solution

5.24. Open container with saturated solution

5.25. Holder of dosed container with saturated solution

5.26. Holder of open container with saturated solution

5.27. Heating chamber

5.28. Cooling chamber

5.29. Excess solution pipe

5.30. Pipe with a pump

9. ECo Sun Central (FIG. 9)

1. light concentrating tube

3. Electrical module of the dark chamber

3.1. Bundles of light transporting cables

4. Dark chamber heating module

5. Dark chamber cooling module

10. Solar thermal greenhouse (FIG. 10)

3.1. Bundles of light transporting cables

7. Greenhouse

11. Solar thermal greenhouse (7), (FIG. 11)

7.1. Construction of the green house

7.2. Pillars of the construction of the greenhouse

7.3. Soil

7.4. Stabilizer of the pillar with an opening

7.5. Underground part of the pillar

7.6. Pillar opening

7.7. Heating body-jar

7.8. Opening of the heating body-jar

7.9. Silicone seal

7.10. Radiating heat and light

7.11 Heat absorber

7.12. Insulator

7.13. Wire end of multi wire cable

7.14. Exit Sun light

7.15. Clamping strips

1.7. Light transporting multi wire cable

2.4. Light transporting full cable

3.1. Bundles of light transporting cables

According to the invention, the Sun rays (1.1) are collected and transported with the help of a light concentrating tube (1) FIG. 1, FIG. 9 which in its upper part has a convex lens (1.2) and a Fresnel lens (1.3) with a body of a concentrating tube (1.4) which are joined in one unit, where the body of the concentrating tube (1.4) is outwardly coated with a mirror coating (1.5) while on the upper side part is a vacuum pin (1.8), the lower part of the body of the concentrating tube (1.4) has an introducer for a light cable (1.6) on a fight transporting multi wire cable (1.7) with transported concentrated light (1.11) and with insulation (1.10) which is attached to the introducer for a light cable (1.6) with a silicone seal (1.9) to the light concentrating tubes (1) and they are placed in the lattice earner for light concentrating tube (1.12) FIG. 1, FIG. 2

An energy combined sun central has an optional solution, light concentrating funnel (2) FIG. 3 consisting of a convex lens (1.2) and a Fresnel lens (1.3) placed on the upper grid (2.9) of the grid mount (2.8) while the light funnel (2.1) with the fiber extension (soldered to light transporting full cable) (2.3) is placed in the lower grid (2.10) of the grid mount (2.8) where between the convex lens (1.2) and the Fresnel lens (1.3) in accordance to the position of the light concentrating funnel (2) there is an air distance (2.6) for the passage of focused light rays (2.5). The light funnel (2.1) has an external mirror coating (2.2) while at the fiber extension (soldered to light transporting full cable) (2.3) is sealed a light transporting full cable (2.4). Concentrated light (1.11) and (2.7) from light concentrating tubes (1) and light concentrating funnels (2) is transported to the electrical module of the dark chambers (3) FIG. 5, FIG. 9 by light transporting multi wire cables (1.7) with insulation (1.10) and light transporting full cables (2.4) that form bundles of light transporting cables (3.1). FIG. 3, FIG. 4

An electrical module of dark chamber (3) consists of an outer metal construction (3.3) in the form of a cuboid on which outer sides is placed sandwich insulation (3.4) metal legs (3.7) with wheels (3.8) and carriers with coupling elements (3.19) while at one of the lateral sides there is attached and connected voltage control unit (3.15) and the inverter (3.16) with batteries (3.23) through electrical cable for batteries (3.24), on the lower surface on an electrical module of the dark chamber has an air inlet opening (3.22) with air filter (3.12) inserted in the air fiber holder (3.21). On the upper side of the electrical module of the dark chamber (3) through the sandwich insulation (3.4) are built in tubular openings (3.13) with built-in fans (3.14) connected to the thermal probes (3.17) through the electrical cable (3.18) with voltage control unit (3.15). In the inner central space of the outer metal construction (3.3) with sandwich insulation (3.4) is attached an inner metal construction (3.5) fastened with metal joint elements (3.6) for the outer metal construction (3.3) whereby on all six sides of the inner metal construction (3.5) are fastened photovoltaic panels (3.9). Through the tubular opening (3.2), enters one or more bundles of light transporting cables (3.1) that pass through the air space (3.20) between the outer metal constructions (3.3) and inner metal construction (3.5), tubular openings (3.2) enters through the photovoltaic panels (3.9) set on holders (3.11) after previously removed and transmitted photovoltaic cells (3.10). Bundies of the light transporting cables (3.1) illuminate photovoltaic panels (3.9) and with this process an electrical energy is produced, in this process thermal energy that is released enters the air space (3.20) and with the help of the built-in fans (3.14) placed in the tubular openings (3.13), is transported into the heating module (4) FIG. 5

The dark chamber heating module (4) FIG. 7, FIG. 9 is attached with the electrical module of the dark chamber (3) through the carriers with the coupling elements (3.19) FIG. 5 welded on the corners or the upper surface of the dark chamber electrical module (3) and carriers with coupling elements (4.2) welded to the lower surface of the dark chamber heating module (4). The warm air from the electrical module in the dark chamber (3) goes out through tubular openings (3.13) with built-in fans (3.14) placed on the upper surface of the electrical module in the dark chamber (3) FIG. 5 and enters the hot air inlet tubular openings (4.6) FIG. 7 placed on the lower surface of the dark chamber heating module (4) which is consisted of a metal construction (4.1) with welded carriers with coupling elements (4.2) at the corners of the upper and lower surfaces of dark chamber heating module (4), metal construction (4.1) and carriers with coupling elements (4.2) are insulated with a sandwich insulation (4.3). On the left lateral side of the dark chamber heating module (4) there is an outlet for discharging excess hot air (4.4) with a fan (4.5) which enters dark chamber heating module (4) through hot air inlet tubular openings (4.6) and is transported into the dark chamber cooling module (5) FIG. 8, FIG. 9 through hot air outlet tubular openings (4.7) with fans for outlet of hot air (4.8) placed on the upper surface of the dark chamber heating module (4). The heated air put into the module in the dark chamber heating module (4) through the hot air inlet tubular openings (4.6) is used for air heating by transporting it through the opening for air heating (4.9) with a fan for air heating (4.10) placed on the opposite lateral side of the outlet for discharging excess hot air (4.4), in the inner lower part of the heating module in the dark chamber heating module (4) are integrated spirally placed pipe for sanitary water (4.13) with an inlet opening for sanitary water (4.14) and an outlet opening for sanitary water (4.15). In the upper internal part of the dark chamber heating module (4) is placed a spiral pipe for heating (4.16) with an inlet opening of spiral pipe for heating (4.17) and an outlet opening of spiral pipe for heating (4.18). Functioning of the dark chamber heating module (4) is provided through voltage control unit (4.11) placed on the lateral side on the dark chamber heating module (4) under the outlet for discharging excess hot air (4.4) is connected with electrical cables (4.12) with the fans (4.5), (4.8), (4.10) and the thermal probe (3.17), power supply is performed through the inverter (3.16) placed in the electrical module in the dark chamber (3) directly or through batteries (3.23). FIG. 5, FIG. 7

The dark chamber cooling module (5) FIG. 8 is positioned above the dark chamber heating module (4) FIG. 7 so that with its carriers with coupling elements (5.2) lay down on the upper carriers with coupling elements (4.2) of the dark chamber heating module (4) that consists of a metal construction (5.1) insulated with sandwich insulation (5.3) whose interior is divided into two chambers, one heating chamber (5.27) and one cooling chamber (5.28). The hot air from the dark chamber heating module (4) enters the dark chamber cooling module (5) through the hot air inlet tubular openings (5.6) which lay down on the hot air outlet tubular openings (4.7) placed on the upper surface of the dark chamber heating module (4) in the heating chamber (5.27) on the holder of closed container with diluted solutions (5.20) welded to the metal construction (5.1) is placed a dosed container (5.23) with a diluted solution (5.19) where on the holder of the open container with saturated solution (5.26) an evaporator (5.17) is attached in the open container with saturated solutions (5.24). The closed container with diluted solution (5.23) is insulated with sandwich insulation on all sides (5.3). On the bottom surface of the upper part of the metal construction (5.1) with the holder of closed container with saturated solution (5.25) is attach dosed container with saturated solution (5.22) is secured, with a saturated solution (5.18) on the upper and lower surfaces of the dosed container with diluted solution (5.22) heat absorbers (5.21) are placed.

The warm air that enters through the hot air inlet tubular openings (5.6) heats the closed container with saturated solution (5.22) and causes evaporation of the saturated solution (5.18) which steam enters the condenser (5.16) placed in the cooling chamber (5.28) where condensed and cooled goes into the open container with a saturated solution (5.24) in which the evaporator (5.17) is placed. The liquid from the inlet of the cooling pipe (5.13) with the help of the pump (5.15) passes through the evaporator (5.17) and cools off and then chilled passes through the cooling pipe (5.12) and exits the cooling module (5) through the outlet of the cooling pipe (5.14). The entrapped air through the tubular opening for entry of outside air (5.7) passes through the cooling chamber (5.28) where it cools and exits through the pipe for air cooling (5.8) with the help of a fan for air cooling (5.9). The excess of the hot air exits through the pipe for outlet of excess air (5.4) using a fan for outlet of hot air (5.5). The closed container with diluted solution (5.23) and closed container with saturated solution (5.22) are interconnected through a pipe with a pump (5.30), whereby the excess of saturated solution is returned back through the excess solution pipe (5.29). The electrical cable (5.11) connects the voltage control unit (5.10) with the thermal probes (3.17), the fans (5.9), (5.5) and the pump (5.15) and pipe with a pump (5.30). FIG. 8

Voltage control units (3.15), (4.11) and (5.10) FIG. 5, FIG. 7 and FIG. 8 consist of voltage input/output (6.1) control smart tile (6.2) control network input/output (6.3), fuse (6.4), switch (6.5), outlet temperature indicator (6.6), inlet temperature indicator (6.7) and thermostats for fans (6.8), DC power input/output (6.9) located on the front of the housing (6.10) while the voltage control unit (3.15) is connected to the internal cables (3.18) FIG. 5 from the electrical module of the dark chamber (3), voltage control unit (4.11) is connected to the internal cables (4.12) FIG. 7 of the heating module of the dark chamber (4), the voltage control unit (5.10) is connected to the internal cables (5.11) FIG. 8 of the cooling module of the dark chamber (5).

Solar energy that is directed through the concentrators with a light concentrating tube (1) and a light concentrating funnel (2) through the light transporting multi wire cables (1.7) and the light transporting full cables (2.4) tied in bundles of light transporting cables (3.1) FIG. 1, FIG. 3 and FIG. 5, regardless of the energy combined sun central are used for external and underground heating of solar thermal greenhouse (7) FIG. 10, which allows more harvests throughout the year, and are consisted of:

Construction of a greenhouse (7.1) with raised on pillars of the construction of a greenhouse (7.2) where pillars of the construction of a greenhouse (7.2) when entering the soil (7.3) with the underground part of the pillar (7.5) they pass through the stabilizers of the pillar with an opening (7.4) they penetrate through the heating body-jar (7.7) through the opening of the heating body—jar (7.8) and the silicone seal (7.9), filled with heat absorber (7.11), in each heating body—jar (7.7), through the pillar opening (7.6) of the pillars of the construction of a greenhouse (7.2), enters the underground set of light transporting full cables (2.4) which are radiating heat and light at their ends (7.10), that heats the heat absorbers (7.11), whose heat is transferred to the heating body—jar (7.7), which underneath has an insulator (7.12), that makes whole day underground heating of the soil (7.3) and with that the roots of plants.

Bundles (3.1) of the light transporting cables (1.7) are split over the soil in the interior of the solar thermal greenhouses (7), rising tied with clamping stripes (7.15) along the pillars of the construction of a greenhouse (7.2) on their outer sides and they are split to wire ends of multi wire cable (7.13) along the lower surfaces of the construction (7.1) bound with damping strips (7.15) radiating light. FIG. 10, FIG. 11

1. Energy combined sun central is consisted of sunlight concentrators (1) and (2) bundles of light transporting cables (3.1), electrical module of the dark chamber (3), dark chamber heating module (4) dark chamber cooling module (5), indicated by, the convex lens (1.2), the Fresnel lens (1.3) and the body of the concentrating tube (1.4) are cast in one piece, where the body of the concentrating tube (1.4) is coated with a mirror coating (1.5) and on its upper lateral side has a built-in vacuum pin (1.8) while the light transporting multi wire cable (1.7) is inserted into the introducer for a light transporting cable (1.6).

2. Energy combined sun central has a light concentrating funnel (2) consisting of a convex lens (1.2), a Fresnel lens (1.3) indicated by, convex lens (1.2) and the Fresnel lens (1.3) are cast in one piece and placed on the upper grid (2.9) from the grid mount (2.8), while at the lower grid (2.10) from a grid mount (2.8) is inserted a light funnel (2.1.) with fiber extension (2.3) coated with mirror coating (2.2) so that at the fiber extension (2.3) of the light funnel (2.1.) with fiber extension (2.3) is soldered light transporting full cable (2.4) where the completeness of the convex lens (1.2) and the Fresnel lens (1.3) are height distanced in accordance to the light funnel (2.1) with fiber extension (2.3).

3. Energy combined sun central according to claim 1, indicated by, electrical module (3) has an outer metal construction (3.3) in the form of a cuboid with a sandwich insulation (3.4) and an inner centrally mounted inner metal construction (3.5) with metal joint elements (3.6) welded on the corners on the outside of the inner metal construction (3.5) and the inner sides of the corners of the outer metal construction (3.3), where on all inner sides of the inner metal construction (3.5) are fastened photovoltaic panels (3.9) which with an electrical cable (3.18) are connected to the inverter (3.16), voltage control unit (3.15), thermal probes (3.17) and built-in fans (3.14), where the inverter (3.16) is connected to batteries (3.23) with electrical cable for batteries (3.24) while one or more bundles of light transporting cables (3.1) penetrate through the tubular opening (3.2) in the inner metal construction (3.5) laterally closed by the photovoltaic panels (3.9) whose photovoltaic cells (3.10) are turned to the interior space of the inner metal construction (3.5).

4. Energy combined sun central according to claim 3, indicated by, that the electrical module of the dark chamber (3) on its lower corners has metal legs (3.7) with wheels (3.8), and in the middle section of the lower surface there is an air inlet opening (3.22) with air filter holder (3.21) with an air filter (3.12), while on the corners of the upper surface of the module (3) are mounted carriers with coupling elements (3.19) where in between are tubular openings (3.13) with built-in fans (3.14) this air enters the electrical module of the dark chamber (3) in the air space (3.20) and is heated by the bundles of light transporting cables (3.1) and the photovoltaic panels (3.9) and exits through the tubular openings (3.13) with the built-in fans (3.14) and enters the hot air inlet tubular openings (4.6) of the heating module of the dark chamber (4) that are drawn to the tubular openings (3.13) of the electrical module of the dark chamber (3).

5. Energy combined sun central according to claim 3 indicated by, that the entrained heated air in the module (4) from the electrical module of the dark chamber (3) heats the pipe for sanitary water (4.13) with an inlet opening for sanitary water (4.14) and an outlet (4.15) and the heating pipe (4.16) with the inlet opening of spiral pipe for heating (4.17) and the outlet opening of spiral pipe for heating (4.18), with the hot air enters into the hot air outlet tubular openings (4.7) with the fans for outlet of hot air (4.8) which are pushed into the cooling module of the dark chamber (5) through the hot air inlet tubular openings (5.6).

6. Energy combined sun central according to claim 1, indicated by, the electrical module of the dark chamber (3) is connected to the heating module of the dark chamber (4) and the cooling module of the dark chamber (5) so that the carriers with coupling elements (4.2) placed on the lower surface of the module (4) lie on the carriers with coupling elements (3.19) placed on the upper surface of the module (3) while the cooling module of the dark chamber (5) leans with the carriers with coupling elements (of dark chamber cooling module) (5.2) on the carriers with coupling elements (4.2) of the heating module of the dark chamber (4), which forms the physical compactness of the energy combined sun central.

7. Energy combined sun central according to claim 1, indicated by, the concentrators (1) and (2) insert into the greenhouse (7) the focused light rays (2.5) by light transporting multi wire cables (1.7) and light transporting full cables (2.4) tied in bundles (3.1) so that the bundles (3.1) of the light transporting full cables (2.4) are buried into the soil (7.3) and with part of the light transporting full cables (2.4) are penetrating through pillar opening (7.6) inside the underground part of the pillar (7.5) of the pillars of the construction of the greenhouse (7.2) penetrating the heating body-jar (7.7) through the opening of the heating body-jar (7.8) and the silicone seal (7.9) in the heat absorber (7.11) while the bundles of light transporting cables (3.1) are placed on soil (7.3) where parts of the light transporting cables (1.7) are tied to the outer sides of the pillars of the construction of the greenhouse (7.2) with wire ends of multi wire cable (7.13) on the lower surfaces of the construction of the green house (7.1)
